(19) United States
(12) Patent Application Publication
(10) Pub. No.: US 2011/0159465 A1
(43) Pub. Date: Jun. 30, 2011

(54) Networked education and entertainment technology

(76) Inventor: Rick Gutridge, Peoria, AZ (US)

(21) Appl. No.: 12/927,163

(22) Filed: Nov. 9, 2010

Related U.S. Application Data
(60) Provisional application No. 61/280,838, filed on Nov. 9, 2009.

(51) Int. Cl. G09B 19/00

(52) U.S. Cl. 434/154; 434/188; 434/276

(57) ABSTRACT

This invention is intended to improve immersive simulation techniques. The integration of five components constitutes a new method creating an educational experience that will improve student levels of interest and performance in STEM and other subjects. The five components are:
Physical hardware (representing real or simulated items),
Facilities and supporting staff (representing themselves or facsimiles of non-contemporary facilities and staff)
Media in various forms and formats including: advertising, news, music, film or other types produced for either broadcast or internet outlet.
Dramatic stories that cohesively integrate items 1, 2 and 3 to enhance the educational experience.
Linking technologies that enable the control and transmission of data and other information between the physical hardware and applicable personnel.

The combination of these components constitutes an education method that creates a networked ‘virtual reality’ designed to engage the imaginations of students and raise their level of interest in educational materials.

### CROSS REFERENCE TO RELATED APPLICATIONS

Inventor claims the benefit pursuant to 35 U.S.C. §119(e) of the Nov. 9, 2009 filing date of Provisional Application No. 61/280,838 by the same inventor.

### STATEMENT REGARDING FEDERALLY SPONSORED RESEARCH AND DEVELOPMENT

This invention was not made using Federally Sponsored Research and Development. The inventor retains all rights.

### THE NAMES OF THE PARTIES TO A JOINT RESEARCH AGREEMENT

N/A.

### REFERENCE TO A SEQUENCE LISTING

N/A.

### BACKGROUND OF THE INVENTION

The nation's ability to compete in the global economy requires American students be proficient in Science, Technology, Engineering and Mathematics (STEM). Their lack of proficiency has become a nationally recognized concern. The National Center for Education Statistics, run by the United States Department of Education provides standardized test scores for American fourth graders and eighth graders in basic reading, writing, math and science. The data clearly shows that despite ever increasing levels of spending on education, American students continue to fail standardized tests designed to measure their proficiency in these four subjects. What is apparent in the data is that a different approach to education is needed.

As further evidence of the national concern over student performance, particularly in STEM, NASA is developing a $1.3 million massively multi-player on-line [video] game (MMOG) just to explore methods for stimulating student interest in these subjects. Other organizations engaged in STEM education include the Challenger Center for Space Science Education. They have developed a simulation system designed to replicate near-term NASA missions in an attempt to teach and inspire the pursuit of STEM and STEM-related subjects. Other less prominent efforts to address STEM education are underway across the nation by organizations both public and private.

NASA's MMOG approach will need to produce a competitive version of the genre capable of captivating student interest while effectively addressing STEM education issues. The NASA product will be up against popular on-line video games such as Halo® and World of Warcraft®:
“IRVINE, Calif.—Jan. 23, 2007—Blizzard Entertainment® today announced that World of Warcraft®: The Burning Crusade™ has broken the day-one sales record to become the fastest-selling PC game ever in North America and Europe, with a worldwide total of nearly 2.4 million copies sold in the first 24 hours of availability. The Burning Crusade, the first expansion set for World of Warcraft, was simultaneously released in North America, Europe, Singapore, Thailand, and Malaysia on January 16 and on January 17 in Australia and New Zealand.”

It remains to be seen whether NASA can produce a competitive product. Further, if NASA's on-line approach is successful, it would likely be accessible worldwide and thus would do little to help American students develop a competitive edge over their foreign counterparts.

The Challenger Center for Space Science Education currently offers their 20-year old technology simulating not-too-distant-future NASA-like missions. Their system price, currently near $850,000, is prohibitively high and effectively limits its availability to students. Further, Challenger programs are designed for middle school students (grades 5 through 8) yet another restriction on student access to simulation-based STEM education tools and methods. The Challenger network of about 55 centers collectively reach approximately 400,000 students per year, a very small percentage of our overall student population. The Challenger system simply fails to adequately address the STEM education issues facing the nation.

Preliminary evaluations of TREC's Advanced Spaceflight Laboratory (ASL) have demonstrated its potential to raise the level of student interest in STEM subjects while simultaneously delivering standards-oriented instruction in these areas. Mr. Paul McFarlane, Lead Flight Director at the Challenger Learning Center of Northern Nevada is currently evaluating an Advanced Spaceflight Laboratory prototype simulator named “Horizon” and has provided the following feedback:
“Over the course of several months, we had the opportunity to utilize the lab with pre-school students, elementary school students, middle school students, high school students, Civil Air Patrol Cadets, university students, university faculty (including professors of astronomy, astrobiology, and planetary geology), Reno Air Racing Foundation Board Members, and members of the community at large . . . For each of the groups, the experiences, educational content and storylines were adapted and increased or decreased in detail or complexity depending on their age or educational level; however, the one constant was that each age and interest level was thoroughly engrossed by their excursions into the Solar System . . . and beyond.”

Mr. McFarlane also provided this comment:
“I've had teachers tell me that their middle and high school students truly ‘came alive’ during their simulated journeys. One teacher even commented that several students she'd had for eight months had never talked, asked questions, or really ever been engaged in class until the hour they spent on board Horizon. What an incredible testimony to this project's potential to fire the imaginations of our young people!”

The prototype hardware and software, developed by TREC to explore STEM education issues clearly shows that its approach to immersive simulation can positively impact education. This invention is intended to dramatically improve immersive simulation techniques both in terms of educational impact and cost.

### BRIEF SUMMARY OF THE INVENTION

Current ASL technology is comprised of a copyrighted software simulation of the Solar System presented from the perspective of a futuristic spacecraft capable of flying through the Solar System to its various planets and moons. The existing software produces accurate, photo-realistic imagery and also provides features designed to support the teaching of a variety of concepts related to math and science. These additional software features include maps, latitude and longitude overlays, constellation outlines, multiple orbit modes (polar, solar, equatorial and retrograde motion demonstration) and overhead slides to support lectures and other on-board student activities.

The aforementioned software can be presented in a variety of packages including trailers, structures built inside buildings or other forms. The intent is that the software be presented to students and others in a cabin designed to look and feel like a futuristic spacecraft, similar to ones seen in popular science fiction television programs and movies. The spacecraft cabin design, operating in conjunction with the software, provides a completely unique and flexible educational environment that effectively takes students out of their normal frame of mind. It is one thing to see photographs of Jupiter and its moons on a personal computer in the classroom. It is quite a different experience to see the same view out the window of your spacecraft. The experience is especially powerful for younger students whose vivid imaginations are more easily stimulated.

TREC has built two prototype simulators, each operates in a large enclosed trailer and each has been taken to schools and other venues for program delivery. In particular, TREC has delivered multiple lectures on the planets to young students in kindergarten, first and second grades. Without exception, these young students were captivated by the experience and invariably one of the children would ask: “Are we really in space?” The unique ASL environment clearly fascinates young minds and TREC believes that as they absorb the details of their surroundings they will also more readily absorb STEM related materials. That is the benefit and power of the credible immersive simulated environment ASL technology provides.

This invention, comprising five disparate components, represents a significant expansion of TREC's existing ASL technology and the positive impact it can have on learning. The incorporation of these additional components will allow the experience had by young students to be extended to older students whose imaginations are more tempered by their growing maturity. When integrated, the following five components constitute a patentable method that creates a new, unique and effective education process. The components are:

Invention Component 1—Physical items that represent facsimiles of real and/or fictional equipment, vehicles or facilities.
Physical items comprised of combinations of computers, displays, user interlaces, software, networking technologies and enclosures, or other combinations of hardware and or software, that are intended to represent some physical item. TREC's Advanced Spaceflight Laboratory simulators/trailers are composed of the aforementioned elements and create a facsimile of a futuristic research spacecraft that is an example of this type of component. A Challenger Learning Center with its mission control room and space station simulators are another example of this element.
   Invention Component 2—Real facilities and people.
These are items that represent themselves or that act as facsimiles of other facilities or persons real or fictional. For example, the staff and/or installation at the National Radio Astronomy Observatory—Very Large Array (Socorro N. Mex.) could represent itself or a futuristic scientific research facility while it interacts with students on-board ASL simulators participating in an educational event through the linking technologies described below. Another example of this type of element would be college professor or other professional that plays a character in the educational event serving as an expert in a particular field.
   Invention Component 3—Simulated and/or real broadcast or Internet media elements such as advertising, news stories, music, entertaining and/or documentary programs and or films and/or other such items.
These elements are used to inject pertinent information into the educational environment and in cases serve to enhance the believability of the environment. They can also be incorporated into the educational event as the primary educational objective. For example, of particular value would be the incorporation of excerpts from historical documentaries presented as though the events were surreptitiously captured live. Using the fictional ability of ASL simulators to travel back in time and launch probes, an educational event for students could involve watching the signing of the Declaration of Independence while the significance of the event is discussed. ASL-NET technologies and the environment they can create would allow for this unique and more interesting perspective on historical events.
   Invention Component 4—Dramatic stories designed to control the introduction and interaction of components one, two and three and which help engage and guide students toward knowledge and understanding of the ASL-NET lesson content.
The degree of drama introduced into ASL-NET educational events can vary. It is possible to create valuable educational experiences with little or no dramatic enhancement. However, whether introduced formally or informally, dramatic elements accentuate the importance of learning activities and the raise the level of engagement students have vis-à-vis that activity.
Using classical dramatic structure, educational activities can be choreographed in a fashion that accentuates their importance for the students that are acting as the story's characters. For example, at some point in the educational drama the plot may call for the ‘ship’ (e.g. an ASL simulator) to be immobilized placing it, the crew and the ‘mission’ in grave danger. The intent of this example of a plot point is to accentuate the importance of a STEM learning activity such as an engineering task to repair a circuit on board the ship so that it and the crew can move to safety. The “dramatic consequence” is that the ship and or the mission could fail if the students responsible for the repairs are unsuccessful in their efforts.
   Invention Component 5—Linking technologies. These are the items that, for the purpose of data transmission and control, connect the underlying physical hardware, software, media and personnel that are associated with the ASL-NET lesson.
An example of a linking technology is one that allows visual communications between the students and other persons associated with the physical elements (equipment and facilities—simulated or real) important to the dramatic story.
In the ASL-NET education method, video conferencing is one example of a generic linking technology that allows a scientist at a government sponsored research facility to assume the role of a “guest star” in an educational drama. The link allows a scientist to interactively engage students providing them with important educational material. The link also allows the scientist to inject elements into the drama (e.g. foreshadowing) that enhance the dramatic quality of the overall experience with its anticipated benefits for students. This educational interaction and dramatic story enhancement cannot be achieved by other means.
Other linking technologies may involve the transmission of specific data from simulator to simulator via the internet, physically wired local area networks and/or cellular telephone networks. Data is defined as a more specific set of information (e.g. the mass of a planet, the position of a ship, etc.) than the information associated with video or audio transmissions.

The integrated/choreographed application of combinations of these five components to new and existing equipment and facilities can create an educational environment that fundamentally changes the relationship between students and curricula. ASL-NET will transform students from third party observers of educational material, to first person participants in an adventure that allows them to interact with the content in a much more engaging fashion. The result is that students will be more interested and will more readily absorb and retain the educational content presented to them via ASL-NET.

### BRIEF DESCRIPTION OF THE SEVERAL VIEWS OF THE DRAWINGS

FIG. 1 is a diagram of how learning centers, research facility, and advanced spaceflight laboratory can be networked.

FIG. 2 is a diagram showing that geographically remote facilities in various states can be networked.

FIG. 3 is a sample design of the inside of a simulator van.

FIG. 4 is a second sample design of the inside of a simulator van.

FIG. 5 is a system diagram showing how the networked facilities can be combined with external data and programs.

FIG. 6 is a plan view of an example of a simulator van design.

FIG. 7 is a side elevation view of a simulator van design.

### DETAILED DESCRIPTION OF THE INVENTION

To provide a detailed description of an application of this invention, the five components to be used in a demonstrative application must first be identified. For this example the following will be used:
1) Representing Invention Component 1 are two ASL simulators. They represent the futuristic research spacecraft and will be operating in separate and distant locations (e.g. Reno Nev. and Yuma Ariz.).
2) Representing Invention Component 2 is a person that serves as an officer in a futuristic space exploration organization. His or her role will be to explain the rules of the both competitive and collaborative educational event and inject dramatic elements, information and education content during the mission. This person will operate from a third location (e.g. Phoenix Ariz.).
3) Representing Invention Component 3 will be simulated news relayed via the character representing Invention Component 2 discussing the discovery of two asteroids on potential collision courses with Earth.
4) Representing Invention Component 4 will be dramatic story elements introduced via video communications equipment on board the simulators and installed at the location in Phoenix. These elements are designed to accentuate the need for student action with respect to a STEM education task. An example of a dramatic element to be injected is information regarding the discovery of new asteroids and the subsequent imperative of surveying these objects because they may impact Earth.
5) Representing Invention Component 5 will be a linking technology that allows visual communications between the students and others associated with the story. As one of the many possible examples, Skype^{@} operating over internet connections will serve as the video links between the character operating in Phoenix Ariz. and the two classes operating in Reno Nev. and Yuma Ariz.

As additional background information, the structure of a classical drama can be roughly defined by the following elements:

1) Act 1—Image
This short section of the drama sets the stage for what the story will be about. A classic example of Act 1—Image is the opening set of scenes of the first Star Wars movie where Princess Leia's ship is being attacked by Darth Vader's. The Image clearly tells the audience that the story is going to be a space-based action adventure.

2) Act 1—Introduction
This element introduces the characters of the story and the central problem, conflict or question about which the plot will revolve.

3) Act 1—Action
This element involves the characters and their initial attempts to resolve the central problem or conflict. In some dramas their first attempt at problem resolution may fail but it leads to information that turns and accelerates the plot in a different direction.

4) Act 2—Turning Point 1
This is a dramatic point in the plot that changes the story direction and imparts a sense of urgency. It requires the characters to reassess their situation and embark on a new course of action. It may be a point where a change in the central problem or conflict may be foreshadowed.

5) Act 2—Action
This portion of the plot is where the characters attempt to resolve the central problem with the new information and/or decisions prompted by the knowledge and events of the first turning point.

6) Act 2—Turning Point 2
The second turning point again provides information that guides the characters and their efforts in a new direction with an even greater sense of urgency. It can foreshadow the ultimate consequence of their success or failure. The second turning point propels the story toward the climax where success or failure is determined.

7) Act 3—Action
Act 3 action sets up the climax of the story where success of failure is determined. It often involves the search for critical information, a battle, or some other action on the part of the characters that is required for the successful outcome of the story.

8) Act 3—Climax
The climax of the story is where the dramatic intensity of the story is highest. During the climax, the specific actions of the characters determine whether they will succeed in resolving the conflict or solving the problem or whether they attempts will fail.

9) Act 3—Resolution
This element concludes the story by wrapping up “loose ends” and by summarizing the ramifications of the characters' efforts at resolving the problem or conflict of the story.

The following sections describe a story developed for an educational event designed to teach middle-school students required Earth Space science material based on state mandated education standards. The educational event, designed using the five invention components described previously, involves students serving as crewmen on research spacecraft tasked with surveying select planets of our Solar System. The survey mission provides an opportunity to expose students to the mandated educational materials while presenting those materials in a much more interesting way. The addition of dramatic elements prompts students to apply their skills under the pressure in order to successfully complete their mission. The following sections describe the educational event in terms of the structural elements of a classical drama titled “Survey of the Solar System”.

### Act 1—Image

Students board their respective ASL spacecraft ‘Horizon’ and ‘Voyager.’ The simulators having been purposely designed to look and feel like a futuristic research spacecraft and immediately inform students that they are to participate in some sort of space oriented activity.

### Act 1—Introduction

As students take their places on-board the ships, a message from Admiral Johnson at ‘Corps of Discovery’ Headquarters is received. It is displayed on the main view screen of both vessels (using the linking technology Skype^{@}). Admiral Johnson chats with the commanders of ‘Horizon’ and ‘Voyager’ as they prepare to get underway. He then addresses the students and explains their mission.

The students ('Corps Cadets') are participating in a survey of our Solar System. The two ships will each survey four of the system's eight planets. They will collect data on the planet, analyze portions of that data during their flight, and return with other data that they will process in the classroom. The mission is both competitive and collaborative. The competitive element involves the time it takes each crew to collect raw survey data and accurately analyze it. These time and accuracy factors determine each crew's score during the event. The collaborative element involves the sharing of each team's data, analysis and conclusions with their counterparts on the other ship once the surveys of their planets are completed.

After reviewing the mission and its objectives, Admiral Johnson wishes both teams good luck and orders them to get underway immediately.

### Act 1—Action

‘Horizon’ and ‘Voyager’ launch from their respective bases on Earth (e.g. Reno Nev. and Yuma Ariz.) and proceed to their first survey targets. Each ship will fly to a pre-assigned planet in the Solar System. Once in orbit around their assigned target, students begin collecting and analyzing data using displays and other tools built into the spacecraft simulator. The data collection and analysis for this mission is designed to teach students the major characteristics of the planets of our Solar System as required by State and Federal education guidelines. Planetary mass, radius, location, composition, length of year and length of day, and whether rings, moons or atmospheres are present constitute the bulk of the survey data to be collected and analyzed. Students will learn required terminology including the meaning of the terms rotation and revolution. In addition, concepts such as phases of the moon and other Earth space science related items will be integrated into their survey activities.

A survey of a planet is deemed complete when the crew advises their Commander that they are ready for a review of their findings. When the ship's commander signs off on the data collected, he advises Admiral Johnson (using the ship's video conferencing system) that his team has completed their survey. Admiral Johnson logs the time and orders the ship to proceed to their next survey planet.

At this point, a team that has completed its survey may contact the other ship and share its findings with its crew as part of the collaborative element of this mission. As an alternative activity, this collaborative work may be done back in the classroom after the simulated survey is completed.

Once the students complete the survey of their first planet, their ship will proceed to its next assigned planet. There it will again collect and analyze planetary data.

### Act 2—Turning Point One

After completing their surveys of their second assigned planets, the Commanders of ‘Horizon’ and ‘Voyager’ each contact Admiral Johnson and report their findings. On the main view screen the Admiral acknowledges receipt of the second survey data and then advises the crew of the discovery of two previously unknown asteroids by ‘MPR’ or Minor Planet Research.

The Admiral informs the Commanders of ‘Horizon’ and ‘Voyager’ that these new objects may be added to their survey mission if ‘MPR’ analysis indicates any risk of these asteroids impacting Earth. The two ships are to continue with their survey missions as planned until advised otherwise.

The purpose of this communication is to inject dramatic tension into the educational event by implying that Earth may be damaged or destroyed by an asteroid impact. That students will need to survey these objects because of the threat they potentially represent imparts additional importance to the STEM tasks the students are already performing.

Also note that ‘MPR’ is a non-profit organization operating out of Scottsdale Ariz. in partnership with the Lowell Observatory in Flagstaff Ariz. for the purpose of identifying asteroids whose orbits cross those of Earth thereby representing an impact hazard. The inclusion of ‘MPR’ is an example of Invention Component 2; a real person or organization participating in the educational event. A variant of this educational event could include direct video communications with an ‘MPR’ representative who could interactively work with students explaining the many interesting attributes of asteroids and why they represent a potential hazard to Earth.

### Act 2—Action

The two ships continue to collect and analyze data at their third and fourth survey planets, but their respective commanders ask their crews to perform their work quickly and efficiently as they may need to add another target to their survey. If an asteroid is to be added to the survey mission, the extra time required will consume fuel and fuel reserves may become an issue.

### Act 2—Turning Point 2

‘Horizon’ and ‘Voyager’ are each surveying their fourth planets when another video message comes in from Admiral Johnson. On the main view screen he announces that ‘MPR’ has continued to track the asteroids and it appears they may be on a collision course with Earth. He informs the two ships that more accurate information on the position, mass and composition of the asteroids is critical to assessing the impact threat. Admiral Johnson also informs the crew that new autopilot software will be uploaded into the ships' computers to allow them to rendezvous with the asteroids.

Voyager’ and ‘Horizon’ are informed that given their fuel reserves, they'll have just minutes to complete their surveys, but that under no circumstances are they to remain on post beyond the time when they can safely return to Earth. They are ordered to wrap up their work at their fourth planets and proceed to their assigned asteroids as quickly as possible.

### Act 3—Action

With their new autopilot software installed, both ‘Horizon’ and ‘Voyager’ proceed to the asteroids. During transit however, both ships are struck by micro-meteoroids as their deflector systems were improperly calibrated for the flight to the asteroids. The damage is not sufficient cause for cancelling the mission, but it has caused leaks in the fuel systems of both ships, further reducing the time they can spend at the asteroids. As their fuel reserves dwindle, the crews of the two ships race to finish their data collection and analysis activities.

### Act 3—Climax

With knowledge that their fuel reserves are being depleted at a faster than expected rate, both ‘Horizon’ and ‘Voyager’ begin their survey of the asteroids they've been assigned. The commanders of both vessels instruct their crews to focus on the position data calculations and on determining the mass and composition of the asteroid as these are the critical elements in determining its trajectory. Composition will also determine how best to deal with the asteroid should it be on a collision course with Earth. The crew must work quickly as fuel and time are running out.

When the critical data is collected, processed and analyzed, the Commander conveys the information to Admiral Johnson at ‘Corps of Discovery’ command. He informs the crew that their data will be forwarded to Minor Planet Research where they will use it to refine their orbital calculations for the asteroid surveyed. The Admiral then orders the ship to return home at best possible speed.

### Act 3—Resolution

Upon returning to Earth, the two ships land at their respective bases. Before the crew's disembark, their commanders contact ‘Corps’ Command and ask for an update from Admiral Johnson, who congratulates the crew on their performance. The Admiral advises the two crews that ‘MPR’ has yet to complete their analysis but that when the information is available it will be forwarded on to them. Note that the analysis results will be included in the teacher's mission preparation packet and during the post-mission classroom activities the results that showed the asteroids will pass very close to Earth, but not hit it, can be shared.

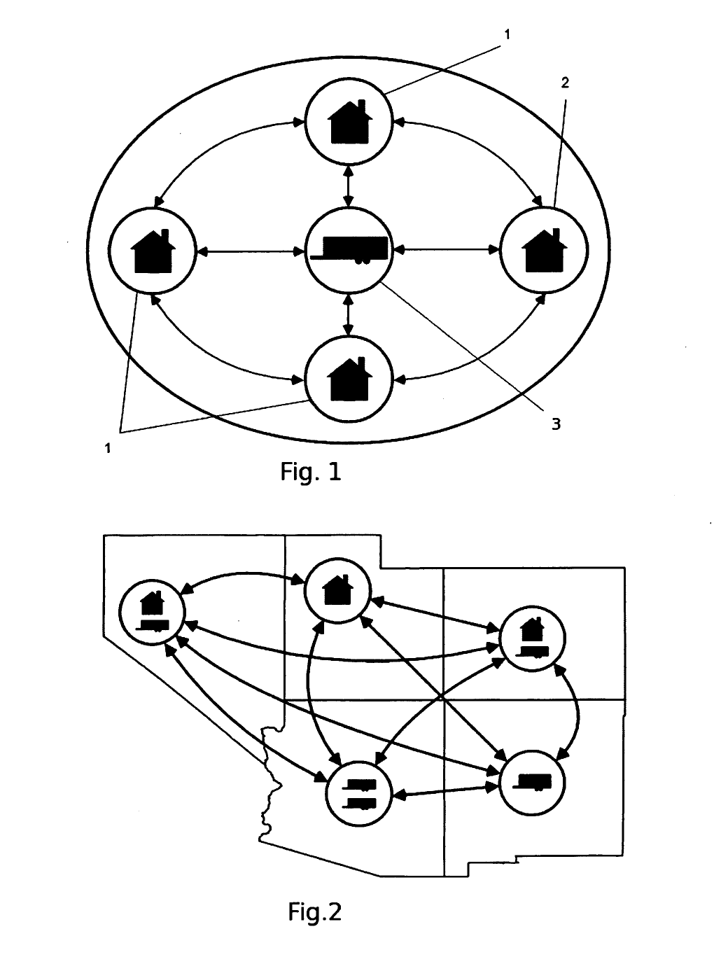

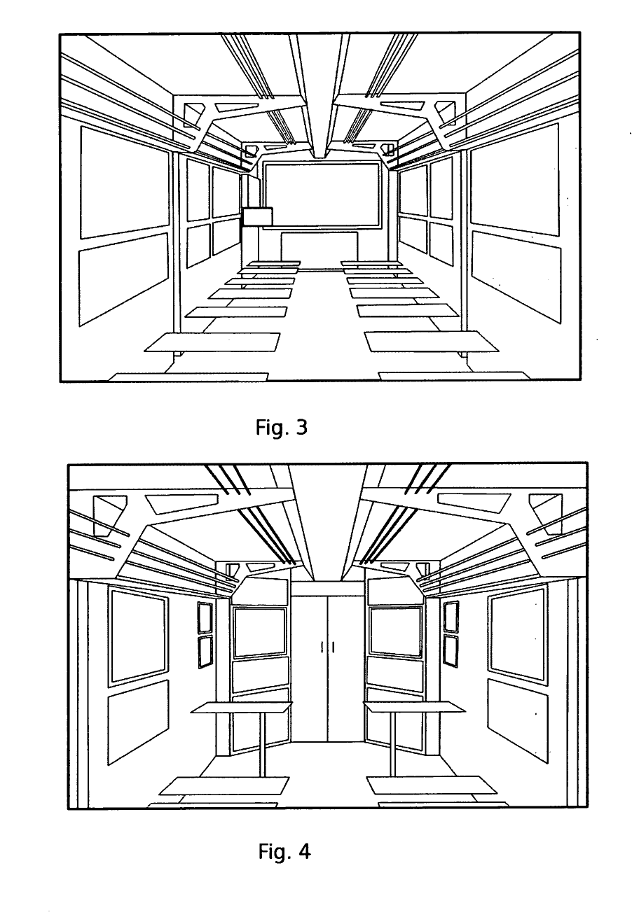

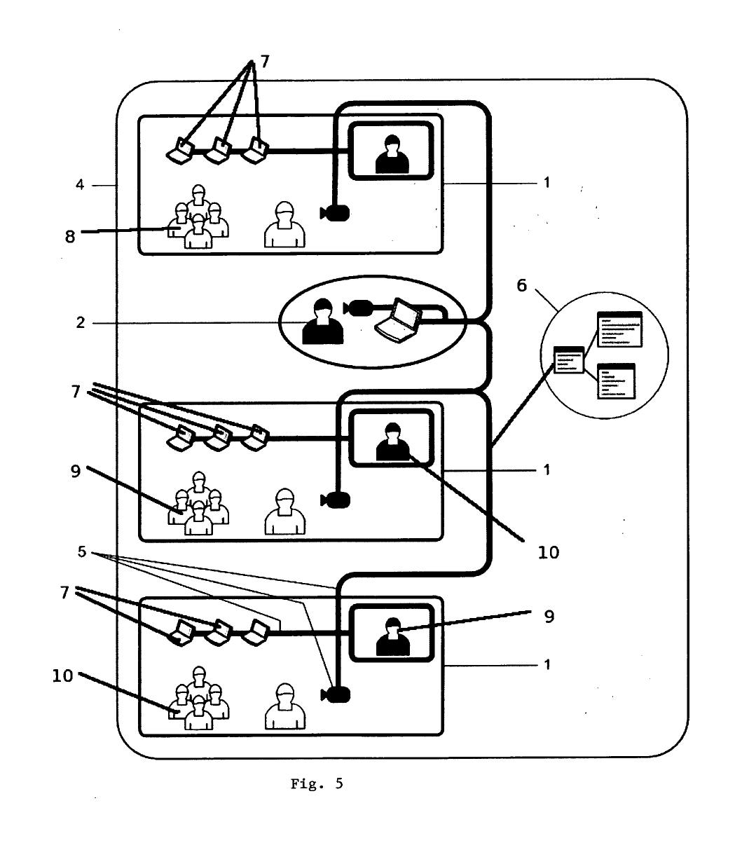

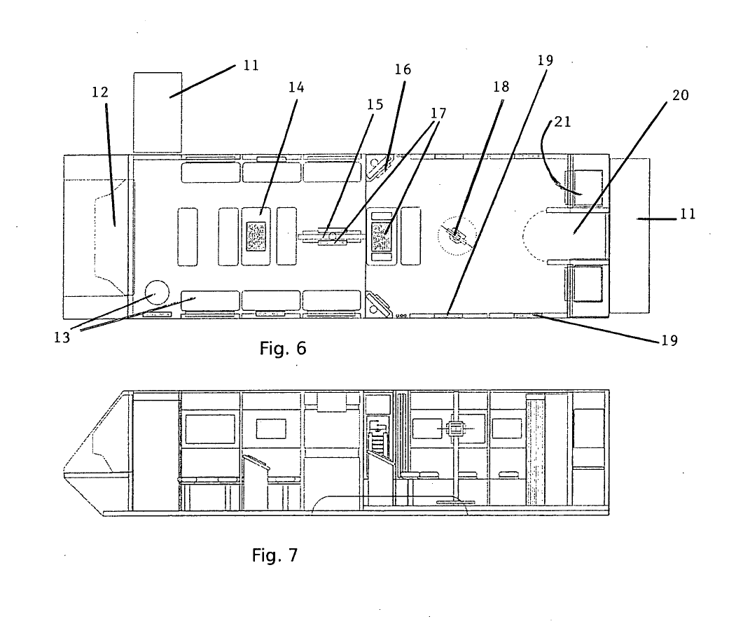

In FIG. 1 there are learning centers (1), a research facility (2), and an advanced spaceflight laboratory (3). In FIG. 5 there is a learning center (1), a research facility (2), a dramatic story context (4), linking technologies (5), media components (6), student interfaces (7), a class A (8), a class B (9), and a class X (10). FIGS. 6 and 7 have an advanced Spaceflight Simulator design in plan and side views showing various design features used to create the look and feel of a futuristic research spacecraft and to provide facilities for teaching STEM and other subject matter. There is a wheelchair ramp access (11), a main view screen (12), seats (13), a command console (14), a chart center (15), an engineering systems panel (16), LCD monitors (17), a periscope/telescope (18), crew data collection and analysis stations (19), a simulated air lock (20), and lab facilities (glove boxes) (21).

I claim:

1. A method of education comprising the steps of:
providing computer hardware;
providing software able to perform tasks selected from the group comprising video conferencing software, data management software, and data transmission software;
providing a network for said computer hardware, said network selected from a group comprising local network, internet, wide area network, and wireless network;
using said software to encrypt data communicated by said computer hardware, said data selected from the group comprising video data and simulation required data;
providing a stage set having simulated physical items and equipment;
using said computer hardware, said stage set, and said software to develop student's interest in science, technology, engineering, and math by presenting a compelling simulated first hand experience of exploration and discovery;
inserting lesson plan tasks into said compelling simulated first hand experience of exploration and discovery to teach lessons to students; and
reinforcing said student's interest in learning said lessons by giving said student's actions meaning within the context of said simulated first hand experience of exploration and discovery.

2. The method of education of claim 1 further comprising the step of:
placing said stage set in a trailer which can be taken to students at remote facilities.

3. The method of education of claim 1 further comprising the steps of:
networking said computer hardware in a plurality of locations; and
scripting said simulated first hand experience of exploration and discovery such that said students located at said plurality of locations must interact as a team to accomplish mission objectives as called for by said lesson plan tasks.

4. The method of education of claim 3 further comprising the step of:
networking said computer hardware with research facilities thereby permitting direct interaction between said students and actual scientists as said students work to complete said lesson plan tasks inserted into the context of said compelling simulated first hand experience of exploration and discovery.

5. The method of education of claim 1 in which said lessons are about subjects selected from a group comprising science, technology, engineering, history, culture, health, environmental awareness, and math.
